(19) United States
(12) Patent Application Publication
(10) Pub. No.: US 2026/0162057 A1
(43) Pub. Date: Jun. 11, 2026

(54) COMPUTER-IMPLEMENTED METHOD AND SYSTEM FOR MANAGING DIGITAL ASSETS WITHIN AN INDUSTRIAL FACILITY

(71) Applicant: Siemens Aktiengesellschaft, Munchen (DE)

(72) Inventor: Dmitry Ledentsov, München (DE)

(21) Appl. No.: 18/973,879

(22) Filed: Dec. 9, 2024

(51) Int. Cl. G06Q 10/087

(52) U.S. Cl. CPC G06Q 10/087

(57) ABSTRACT

The present invention relates to a computer-implemented method for managing digital assets within an industrial facility which are stored in an inventory list, whereby adding a digital asset and/or any change in the state of a digital asset causes a change in the inventory list, wherein such adding and/or such a change is recorded as an event in an immutable append-only log.

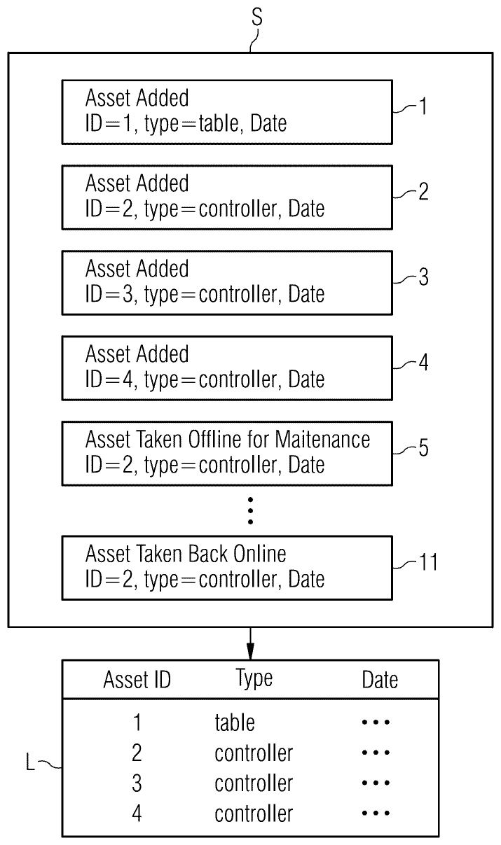

### FIELD OF TECHNOLOGY

The present invention relates to a computer-implemented method and system for managing digital assets within an industrial facility.

### BACKGROUND

Digital assets can be components (hardware components and/or software components) like devices installed and/or operated within an industrial facility (plants/factory). Maintenance for hardware can be replacing spare parts or repairing parts of a component. Maintenance for software can be a firmware and/or software update or integration of new/further functionalities. Such functionality can be a fast detection of safety risks (e.g. collision of AGV (autonomous guided vehicle) or robot) due to additional sensor(s)/camera device(s). Further functionality can also be network device that acts as a gateway to additional other digital assets or as a hub to additional sensors. Such digital assets are often stored in an inventory list in a table-based or database format. If such an asset is added to other components in the factory or is set “offline” e.g. due to maintenance the state(s) of the digital asset is changed or all influenced digital assets by the added asset are changed. A “real” state change usually brings about a change in the inventory list/catalogue as well. If a catalog user makes a new finding, such as that some digital assets need to be split into multiple assets, combined or otherwise related, this requirement must be fulfilled by the implemented asset schema. Changes performed on the catalog are usually transactional, however, the history of changes are usually lost from one transaction to another, unless implemented as a separate field int the table or table in the database. For audit, operation and maintenance purpose (state) changes shall remain transparent and traceable and maybe durable in order to avoid inconsistency the inventory list and to reduce failure in operation of the components and to avoid loss of crucial information needed in regulatory processes.

In view of this, it is an objective of the present invention to present an improved concept or method or system that assists auditability of changes in the inventory list.

### SUMMARY

The above-mentioned object is achieved by a method and one or more apparatus and/or a system and/or a device according to the features of the independent claims.

Preferred embodiments of the invention are described in the dependent claims. Any combination of the features of the dependent claims to each other and with the features of the independent claims is possible.

A first aspect of the invention is a computer-implemented method for managing digital assets within an industrial facility which are stored in an inventory list, whereby adding a digital asset and/or any change in the state of a digital asset causes a change in the inventory list, wherein such adding and/or such a change is recorded as an event in an immutable append-only log. Changes in the inventory list and/or the state changes of the digital assets are auditable by rebuilding at least one former version of the inventory list as one or more responses to the events in said log. So the assets states themselves and their in the past e.g. “at time X how was the state of the list” can be audited.

By storing the detection of a changes as an event in an immutable event log preferably in the order in which it occurred, the inventory list is auditable by design (all events are stored and can be read for audit reports). The list can be reconstructed from past changes on the digital asset. So history of changes can be kept.

The data fields, specific to each identifiable asset can be reconstructed from the event log on demand via projections, without defining a common data model that unifies potentially incompatible asset categories. Projections in Event Sourcing are a way to derive the current state from an event stream. This can be done asynchronously as events are persisted to an event stream (stored in the event log) which can update a projection. So replay of all the events in an event stream to get to the current state, is not necessary when it comes to displaying in a UI or reporting application. Projections in Event Sourcing are mostly known in business cases (see https://codeopinion.com/projections-in-event-sourcing-build-any-model-you-want/). In addition aggregated views on multiple assets can be reconstructed from asset lists or lists of certain state changes.

Views, such as user interfaces showing the inventory list, or filterable list APIs (application programming interface) can be likewise reconstructed for a particular use case or device catalog from the event log by adding projections of the event log. Shall the catalog/list user make a finding or run a process that adds new assets to the inventory list, the new or modified projections of the event log into new views can be made independent of any other views.

Additional processes can be created that generate events, such as regular digital asset discovery processes or new types of changes performed on the assets.

A view providing a list of online digital assets, which are currently in operation, can be projected from the events in said log, whereby, if at least one new event is recorded in said log, the list is updated by projecting the at least one new event into the list.

A change in the state of a digital asset can represent a need for maintenance which leads to take the digital asset offline out of operation. A change in the state of a digital asset can also represent a performed maintenance which leads to take it back online in operation. Both state changes can be recorded in said log.

According to an embodiment of the invention a view which merges (matches) at least two redundant digital assets in the inventory list ca be projected from the events in said log. Discovered assets can be stored in an immutable log of discovery events. Use of projections from that log into views, such as a linear list of digital assets, can apply deduplication logic within the projections. So redundant digital assets can be sorted out or merged.

According to an embodiment of the invention at least a portion of the digital assets in the inventory list are labelled as belonging to a pre-defined category, whereby each labelling event is recorded in a second immutable append-only log. A categorization of one or more digital assets can be transformed and stored in a second immutable log of categorization events. Each application of a categorization rules (categorization run) has usually a unique identifier. Categorization rules and validation rules used by a categorization run are stored and can be retrieved via the identifier. The immutable log of categorization events is used to reconstruct (project) the assets belonging to a category, and categories an asset belongs to.

A further aspect of the invention further is a system comprising at least one processor which is configured to perform a method for managing digital assets within an industrial facility which are stored in an inventory list, whereby adding a digital asset and/or any change in the state of a digital asset causes a change in the inventory list, wherein such adding and/or such a change is recorded as an event in an immutable append-only log.

The system can include one or more processors or can be connected to a computing system (e.g. a server or cloud) integrating one or more processors.

Embodiments as described above for the computer-implemented method can be analogous applied for the system and for computer program (product) and for the computer-readable storage medium.

The computer-readable storage medium stores instructions executable by one or more processors of a computer, wherein execution of the instructions causes the computer system to perform the method.

The computer program (product) is executed by one or more processors of a computer and performs the method. A provisioning device can store and/or provide the computer program product.

### BRIEF DESCRIPTION

The foregoing and other aspects of the present invention are best understood from the following detailed description when read in connection with the accompanying drawings. For the purpose of illustrating the invention, there are shown in the drawings embodiments that are presently preferred, it being understood, however, that the invention is not limited to the specific instrumentalities disclosed. In the FIGURES, identical or functionally identical elements are denoted by identical reference signs. Included in the drawings are the following FIGURES:

The FIGURE shows a event data stream which is recorded and resulting in an inventory list.

### DETAILED DESCRIPTION

For example, a factory contains assets, such as devices, machines and tools. During its initial design phase, assets are added to an inventory list/catalogue. During operation of a factory, some assets will be added, removed or changed. Some assets will, for example, be taken offline for maintenance, and then taken back online (returned into service).

Initially the focus lies on a plain list of devices that the factory, but with time, more precise queries are needed. An example of a query could be “all devices that have been in maintenance at least twice”.

The changes are represented by a (linear) append-only log of events that are immutable (will not be modified). The FIGURE shows an example of an event data stream S which is recorded.

The following events are recorded:
[1] AssetAdded id=1, type=table, . . .
[2] AssetAdded id=2, type=controller, . . .
[3] AssetAdded id=3, type=controller, . . .
[4] AssetAdded id=4, type=controller, . . .

When two controllers are taken out of service, the following events are recorded:
[5] AssetTakenOfflineForMaintenance: id=2
[6] AssetTakenOfflineForMaintenance: id=3

After that some more events may happen:
[7] AssetTakenBackOnline: id=2
[8] AssetTakenBackOnline: id=3
[9] AssetDefectDetected: id=2
[10] AssetTakenOfflineForMaintenance: id=2
[11] AssetTakenBackOnline: id=2

A pseudo-code example of a projection logic to view an inventory list L of all devices belonging to the factory can be:

Starting with an empty list of assets LA (e.g. in a persistent system, such as a database) For each event:

```
If event.type == AssetAdded:
    Append Asset(id=event.attributes.id,
    type= event.attributes.type,...) to LA
```

This results in an inventory list L as shown in the FIGURE and below:
Asset id=1, type=table, . . .
Asset id=2, type=controller, . . .
Asset id=3, type=controller, . . .
Asset id=4, type=controller, . . .

In the following an example of projecting a list of Controllers is shown which are currently active in operation.

The need for managing assets of type controller has become important, and a new view is needed for maintenance, as opposed to searching manually in the simple catalog, and looking back at the event log to see if it has been taken offline, or physically inspecting the asset state.

The projection logic of this query can be:

Starting with an empty list of assets LAA

For each event:

```
If event.attributes.type == controller:
If event.type == AssetAdded:
    Append Asset(id=event.attributes.id,
    type= event.attributes.type,...) to LA
If event.type == AssetTakenOfflineForMaintenance:
    Remove Asset(id=event.attributes.id,...)
If event.type == AssetTakenBackOnline:
    Append Asset(id=event.attributes.id,...)
```

A comparable projection logic, depending on the necessities of the technologies can be:

Resulting in the following list at the time after event [8]:
Asset id=2, type=controller, . . .
Asset id=3, type-controller, . . .
Asset id=4, type=controller, . . .

At the time after event [10]:
Asset id=3, type=controller, . . .
Asset id=4, type=controller, . . .

Resulting in the following list at the time after event [11]:
Asset id=3, type=controller, . . .
Asset id=4, type=controller, . . .
Asset id=2, type=controller, . . .

A further embodiment of the invention is to remove/merge at least two redundant digital assets in the inventory list.

Discovered assets as redundant are stored in an immutable log of discovery events and use projections from that log into views, such as a linear list of digital assets, wherein deduplication logic within the projections is applied. Multiple projections into multiple views can be utilized in parallel. Deduplication logic can be changed on demand by a user of a concrete view.

A further embodiment of the invention is to categorize the digital assets of the above described inventory list.

Starting with a set of uncategorized digital assets and at least one defined rule which categorize the assets into pre-defined categories. At least a portion of the digital assets in the inventory list can be labelled as belonging to a category of the pre-defined categories. Categories can represent asset's type, former states, location etc.

A first set of rules (categorization rules) is a list of expressions e.g. of the form: query_expression_on_asset INTO_CATEGORY category

A further set of rules is a list of rules (validation rules) that validates the application of the first set of categorization rules.

A definition of a categorization expression of the type INTO_CATEGORY causes a rule to be added for each asset e.g. in the form asset IS_IN category

Further validation expressions can have the form:
count (category) comparison number
where comparison can be ==, >=, <=, >, <, !=

Firstly, the set of categorization rules is applied on the uncategorized assets, and outputs a summary of the result after categorization (count of assets in each relevant category, frequency of assets categorized in more than one category), and it outputs the results of the validation rules, allowing for correction of the categorization rules.

Secondly, categorization transforms the list of digital assets into an immutable log of categorization events.

The immutable log of categorization events is used to project the assets belonging to a category, and categories an asset belongs to.

The structure of the categorization event can be:
type: CATEGORIZED_INTO
asset_id: ID
category: Category (ID or any other appropriate type)
categorization_run_id: ID
categorization_rules_id: ID

To project the event log of categorization events into a mapping of asset to categories: let asset_to_categories=new Map<ID, Set<Category>>

for each event e of type CATEGORIZED_INTO:
let categories_for_asset_id=asset_to_categories[e.asset_id]

The invention has been described in detail with reference to embodiments thereof and examples. Variations and modifications are possible. Instead of the above-described production process one or more processes can analogously be applied to other technical systems.

For example, a processor, controller, or integrated circuit of the system and/or computer and/or another processor may be configured to implement the acts described herein.

The above-described method may be implemented via a computer program (product) including one or more computer-readable storage media having stored thereon instructions executable by one or more processors of a computing system and/or computing engine. Execution of the instructions causes the computing system to perform operations corresponding with the acts of the method described above.

The instructions for implementing processes or methods described herein may be provided on non-transitory computer-readable storage media or memories, such as a cache, buffer, RAM, FLASH, removable media, hard drive, or other computer readable storage media. A processor performs or executes control of a system. Computer readable storage media include various types of volatile and non-volatile storage media. The functions, acts, or tasks illustrated in the FIGURES or described herein may be executed in response to one or more sets of instructions stored in or on computer readable storage media. The functions, acts or tasks may be independent of the particular type of instruction set, storage media, processor or processing strategy and may be performed by software, hardware, integrated circuits, firmware, micro code and the like, operating alone or in combination. Likewise, processing strategies may include multiprocessing, multitasking, parallel processing and the like.

The invention has been described in detail with reference to embodiments thereof and examples. Variations and modifications may, however, be effected within the spirit and scope of the invention covered by the claims. The phrase “at least one of A, B and C” as an alternative expression may provide that one or more of A, B and C may be used.

The terminology used herein is for the purpose of describing particular embodiments only and is not intended to be limiting of example embodiments of the invention. As used herein, the singular forms “a”, “an”, and “the” are intended to include the plural form as well, unless the context clearly indicates otherwise.

It is to be understood that the elements and features recited in the appended claims may be combined in different ways to produce new claims that likewise fall within the scope of the present invention. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

None of the elements recited in the claims are intended to be a means-plus-function element unless an element is expressly recited using the phrase “means for” or, in the case of a method claim, using the phrases “operation for” or “step for”.

While the present invention has been described above by reference to various embodiments, it should be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method for managing digital assets within an industrial facility which are stored in an inventory list, whereby adding a digital asset and/or any change in the state of a digital asset causes a change in the inventory list, wherein such adding and/or such a change is recorded as an event in an immutable append-only log.

2. The method according to claim 1, wherein changes in the inventory list and/or the state changes of the digital assets are auditable by rebuilding at least one former version of the inventory list as one or more responses to the events in said log.

3. The method according to claim 1, wherein a view merging at least two redundant digital assets in the inventory list is projected from the events in said log.

4. The method according to claim 1, wherein a change in the state of a digital asset represents a need for maintenance which leads to take the digital asset offline out of operation.

5. The method according to claim 4, wherein a change in the state of a digital asset represents a performed maintenance which leads to take it back online in operation.

6. The method according to claim 1, wherein a view providing a list of online digital assets, which are currently in operation, is projected from the events in said log, whereby, if at least one new event is recorded in said log, the list is updated by projecting the at least one new event into the list.

7. The method according to claim 1, wherein at least a portion of the digital assets in the inventory list are labelled as belonging to a pre-defined category, whereby each labelling event is recorded in a second immutable append-only log.

8. A system comprising at least one processor which is configured to perform a method for managing digital assets within an industrial facility which are stored in an inventory list, whereby adding a digital asset and/or any change in the state of a digital asset causes a change in the inventory list, wherein such adding and/or such a change is recorded as an event in an immutable append-only log.

9. A computer program comprising instructions which, when the program is executed by a computer, cause the computer to carry out a method for managing digital assets within an industrial facility which are stored in an inventory list, whereby adding a digital asset and/or any change in the state of a digital asset causes a change in the inventory list, wherein such adding and/or such a change is recorded as an event in an immutable append-only log.

10. A provisioning device for the computer program according to claim 9, wherein the provisioning device stores and/or provides the computer program product.
